(19) United States
(12) Patent Application Publication
(10) Pub. No.: US 2008/0040754 A1
(43) Pub. Date: Feb. 14, 2008

(54) Pseudo-rich hybrid phone/browser

(75) Inventor: Frederick Chee-Kiong Lai, Waterloo (CA)

Correspondence Address: PERRY + CURRIER (FOR RIM), 1300 YONGE STREET, SUITE 500, TORONTO, ON, M4T-1X3, US

(73) Assignee: RESEARCH IN MOTION LIMITED

(21) Appl. No.: 11/476,844

(22) Filed: Jun. 29, 2006

(51) Int. Cl. H04N 7/20

(52) U.S. Cl. 725/64

(57) ABSTRACT

A markup language specification is set forth for providing pseudo-rich media during phone calls, and to implement two endpoints that support this specification. Each implemented endpoint functions as a half-phone and half-browser, where the phone call consists partly of the traditional full-duplex audio stream between callers, supplemented by pseudo-rich media being transmitted from one party to the other. The pseudo-rich media includes, but is not limited to, text, pictures and hyperlinks.

### COPYRIGHT NOTICE

A portion of this specification contains material that is subject to copyright protection. The copyright owner has no objection to the facsimile reproduction by anyone of the patent document, as it appears in the Patent and Trademark Office patent file or records, but otherwise reserves all copyrights whatsoever.

### FIELD

The following is directed in general to communication devices, and more particularly to a hybrid phone/browser for providing simultaneous audio and visual content while consuming minimal bandwidth.

### BACKGROUND

Phone applications that use cellular networks or WLAN networks are traditionally considered to be audio applications. The content of a traditional phone call is typically limited to a full duplex audio stream that is shared between two or more callers. One problem with audio-only connections is that information is shared very slowly, and is limited by the ability of the listening party to hear the talking party. Some types of information, such as phone numbers, product ID numbers, menu selections, etc., are not well communicated through audio. Background noise, drops in voice quality and the time required to hear an entire pre-recorded audio stream make an indication of specific information unduly laborious and grueling.

Videoconferencing applications have attempted to solve the limitations of audio-only communications by allowing users to send video streams to each other during a call, where the video is captured by respective video cameras (or other video streaming mechanisms) in order to convey images of each caller. The video streams are then transmitted between communication peers for rendering in real-time.

One significant disadvantage of videoconferencing applications is that the bandwidth consumed is extremely large while the information presented is limited only to an image of the remote peer (i.e. the information does not provide much in terms of value added).

It is also known in the art to provide a cellular-phone with a Web browser. However, there is no integration between the phone and browser applications in such prior art devices.

### BRIEF DESCRIPTION OF THE DRAWINGS

The foregoing will be better understood with reference to the description and to the following drawings, in which:

FIG. 1, including FIGS. 1A, 1B, 1C and 1D, is a schematic representation of a mobile device with a user interface supporting communication via the specification set forth herein;

FIG. 2 is a block diagram showing connection of the mobile device of FIG. 1 with a server for providing interactive voice response (IVR);

FIG. 3 is a simplified sequence diagram showing exemplary communication between the mobile device and the server of FIG. 2; and

FIGS. 4A, 4B and 4C are internal architecture diagrams for implementing various exemplary embodiments of the user interface for the mobile device of FIG. 2.

### DETAILED DESCRIPTION

As discussed in greater detail below, a communication system is set forth for providing simultaneous audio and visual content at low bandwidth. A markup language specification is set forth for providing pseudo-rich media during phone calls and for implementing two endpoints that support this specification. Each implemented endpoint functions as a half-phone, half-browser (or half-server, as the case may be). In other words, a phone call consists partly of the traditional full-duplex audio stream between the parties and is supplemented by pseudo-rich media being transmitted from one of the parties to the other. It is contemplated that the pseudo-rich media include, but not be limited to, text, pictures and hyperlinks.

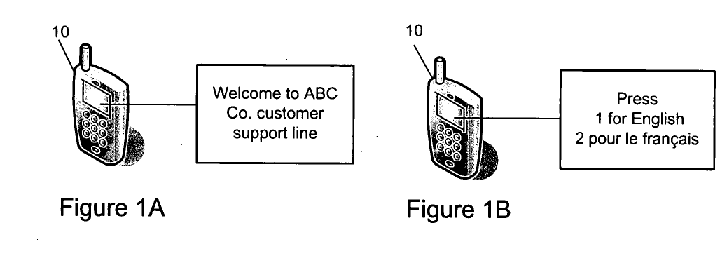

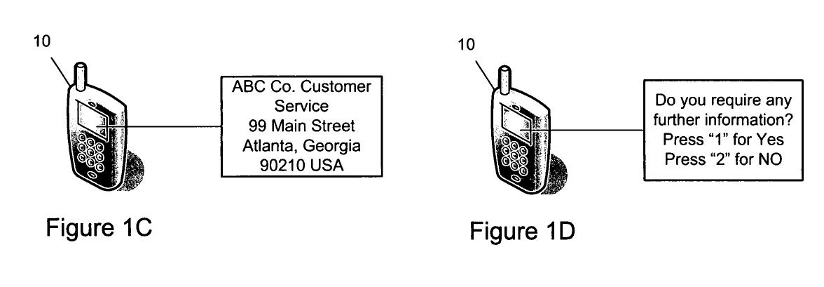

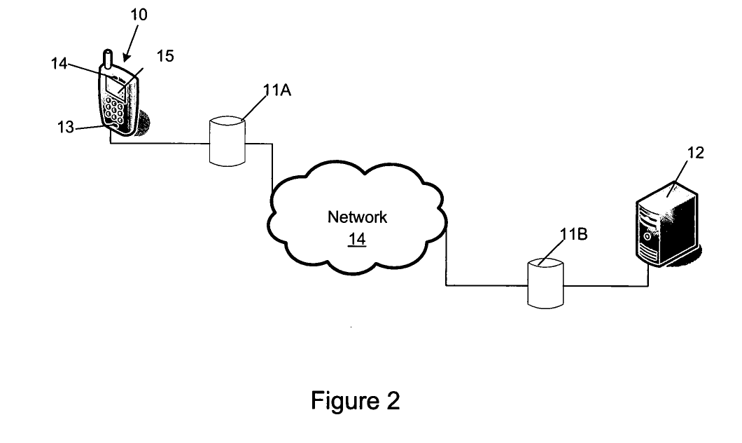

With reference to FIGS. 1 and 2, a first user endpoint is connected to a second user endpoint over a peer-to-peer network. More particularly, a mobile device 10 (first endpoint) having a pseudo-rich phone browser, is connected through a proxy, a gateway or a firewall (designated generally by 11A) to the network 14. It will be appreciated that this connection can include a wireless connection, for a cellular phone, for example. The mobile device 10 includes a microphone 13, speaker or earpiece 14 and a display 15.

A server 12 (second endpoint) is connected to the network 14 via, for example, a proxy, a gateway, a firewall or a load balancer (designated generally by 11B). The server can, for example, include an interactive voice response system (IVR). The network 14 supports a pseudo-rich communication specification, as further discussed below.

According to the example of FIGS. 1A, 1B, 1C and 1D, the user of mobile device 10 places a call to the ABC Company customer support helpline, which utilizes an IVR server 12 that supports the pseudo-rich specification set forth herein.

Once the call between device 10 and server 12 has been established, an automated voice response from the IVR greets the user with an audio message that is reproduced via the speaker 14 at device 10, such as: “Welcome to the ABC Company consumer helpline . . . etc.”. At the same time, through the markup language (i.e. script) discussed below, text corresponding to the voice announcement is displayed as an image at display 15, via the phone browser application (FIG. 1A). The text may be accompanied by a background picture of the company logo or other suitable images. As the script continues, it asks “for service in English, press 1, pour le service en français appuyer sur le 2. To hear this information again, press star”. At the same time, markup information is pushed to the phone at endpoint 10 (FIG. 1B) to display: “Press: 1 for English, 2 pour le français”. In response, the user can, optionally, press “*” to hear the information again from the automated attendant. Since the phone supports pseudo-rich media, however, the user can merely glance at the screen of the phone to view the information rather than pressing “*” to hear the information again.

Alternatively, if the server 12 incorporates voice recognition technology then the user may respond by issuing voice commands that are recognized by the server 12 and then acted upon. Such voice recognition systems are well known in the art.

During the call, the phone 10 receives messages from the IVR server 12 out of band with the audio connection. That is, the user at phone 10 does not hear the data being transmitted to the phone, while the phone decodes the data for display.

The user can continue navigating through the IVR system to find the address of the organization. As the IVR reads out the information for the user to hear, the information is simultaneously displayed, as shown in FIG. 1C.

After receiving the desired information, the user requests shutdown by, for example, responding “no” to the question “Do you require any further information?” (FIG. 1D). In response to receipt of the shutdown request, the call is ended, while retaining the graphic information concerning a contact address on the display screen of the phone 10.

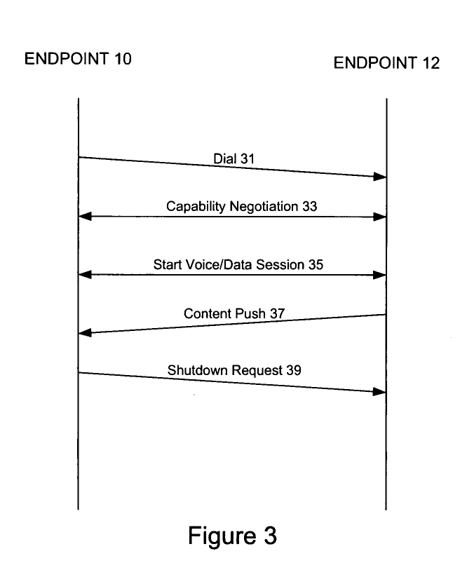

FIG. 3 shows a simplified sequence diagram of messages exchanged to provide simultaneous audio and visual communication between the mobile device 10 and the server 12, according to an exemplary embodiment. The user of mobile device 10 begins by dialing the appropriate number to connect with the second endpoint (Dial 31). After establishing a connection, the pseudo rich phone browser within device 10 and the IVR server 12 negotiate capabilities (Capability Negotiation 33). When the capabilities of the pseudo rich phone browser are determined by the IVR, the voice and data session is started (Start Voice/Data Session 35). The IVR server 12 sends audio to the phone 10 while carrying out speech recognition as well as DTMF tone detection on audio received from the phone. Data content and audio are sent simultaneously by the IVR server 12 to the phone 10 based on audio responses received from the phone (Content Push 37). In carrying out this communication, packet-switched data is transmitted from the IVR server 12 to the phone 10. Data can be pushed to the phone any number of times. In response to receipt of the shutdown request (Shutdown Request 39), the call is ended.

The IVR example of FIGS. 1-3 is but one of many possible examples of a method and apparatus for providing simultaneous full-duplex audio and a pseudo-rich media stream between parties to a call. Additional examples include creating a custom “voice page” on a home server, similar to well-known individual home pages, but which is accessible via a browser-enabled phone 10, and provisioning of a desktop phone browser, as discussed in greater detail below with reference to FIG. 5.

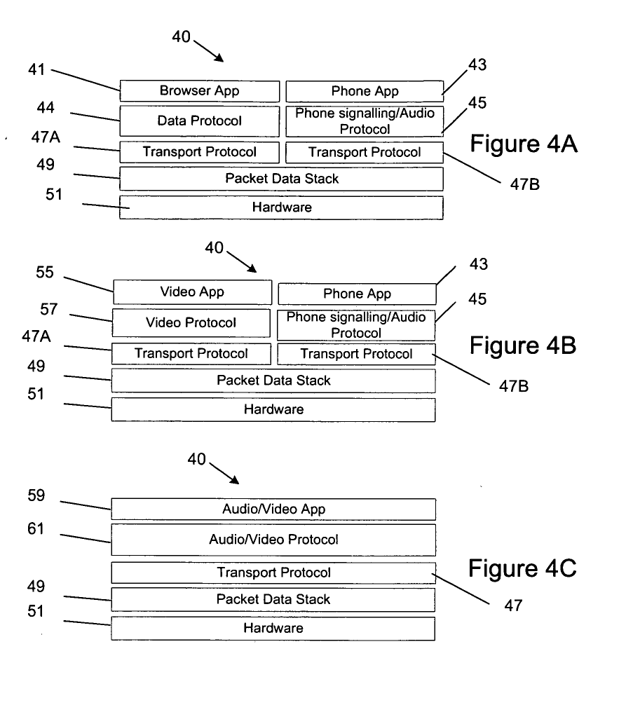

FIG. 4A shows an internal architecture for implementing the user interface 40 within device 10 of FIG. 1, according to one embodiment. According to this embodiment, separate browser and phone applications 41 and 43 are employed while the server 12 coordinates timing for pushing the pseudo-rich browser data, audio and speech recognition. The browser and phone components represent the highest layer (Application Layer 7) of the Open Systems Integration (OSI) model of data networking. Data protocol layer 44 and phone signaling/audio protocol 45 form the Presentation Layer of the OSI model. Transport protocol stacks 47A and 47B (OSI Layer 4) manage end-to-end control and error checking to ensure complete data transfer. Packet data stack 49 forms the data link layer (Layer 2) for node-to-node validity and integrity of the data transmission. Hardware 51 is the physical layer (Layer 1) of the OSI model responsible for passing bits onto and receiving them from the connecting medium.

The data structure of the packets that are transmitted is based on a modified version of the Voice Extensible Markup Language (VoiceXML). The IVR script is written to allow synchronization of voice and data for playback and display. As described above, images are displayed while sounds are simultaneously played back. Exemplary Voice XML code for implementing the pseudo-rich hybrid phone browser of the present application is as follows:

```
<vxml version=“2.0” xmlns=“http://www.w3.org/2001/vxml”
        xmlns:xsi=“http://www.w3.org/2001/XMLSchema-instance”
        xsi:schemaLocation=“http://www.w3.org/2001/vxml
        http://www.w3.org/TR/voicexml20/vxml.xsd”>
<!--begin editable region-->
<table width=“100%” border=“0” cellspacing=“4” cellpadding=“4”>
<tr align=“left” valign=“top”>
<td width=“46%”><img src=“/images/titles/ABC_name.gif” width=“160”
        height=“26” alt=“ABC Company” />
<br />
<span class=“cM”>You have reached ABC Company.
please say the extension or name of the person you with to reach.</p>
<!--INsert some cool graphics code here: animated icon, interesting visual
        effects, etc.-->
<table width=“590” height=“221”
        background=“/images/home/8700_7100_ABC_home.jpg”
        style=“background-repeat:no-repeat”>
<tr>
<td width=“95” height=“150”><a href=“http://www.ABC.com/products
        /index.shtml” target=“other”><img src=“/images/transparent.gif”
        border=“0” width=“95” height=“150” alt=“Product A”>
        </a></td>
<td width=“495” height=“221” rowspan=“2”>
            <a href=“http://www.ABC.com/products/ index.shtml”
        target=“other”><img src=“/images/transparent.gif” border=“0”
        width=“495” height=“221” alt=“Product A”></a></td>
</tr>
<tr>
<!--<td width=“95”><a href=“http://www.ABC.com/news.shtml”
        target=“other”><img src=“/images/promos/customer.gif”
        height=“71” width=“95” alt=“Satisfied Customers”
        border=“0”/></a></td>-->
<td></td>
</tr>
</table>
</td>
</tr>
</table>
<!--end editable region-->
<form id=“no_bargein_form”>
<property name=“bargein” value=“false”/>
<block>
<prompt>
      This introductory prompt cannot be barged into.
</prompt>
<prompt>
      And neither can this prompt.
</prompt>
<prompt bargein=“true”>
        Thanks for calling ABC! Do you know the extension of the
        person you wish to reach?
</prompt>
</block>
<field type=“boolean”>
<prompt>
      Please say yes or no.
</prompt>
</field>
<!--more prompts and voice recognition code and more text displayed on
        the screen.-->
</form>
</vxml>
```

Turning to FIGS. 4B and 4C alternative internal architectures are depicted for implementing the user interface of FIGS. 1-3. Referring first to FIG. 4B, an embodiment is illustrated in which a video application 55 feeds the images, rather than a browser application as in FIG. 4A. The video and phone applications 55 and 43, are separate as in the architecture of FIG. 4A. The server 12, however, coordinates timing for pushing video images, sound and when to carry out speech recognition.

Referring to FIG. 4C, the video and audio are integrated in the same application 59 and protocol 61 as in, for example, a videophone. Server 12 (in this case a video server) therefore coordinates timing for pushing video images, sound and when to carry out speech recognition based on state.

A person skilled in the art, having read this description, may conceive of variations and alternative embodiments. For example, the data structure of the packets that are transmitted is not limited to a modified version of VoiceXML as other data structures and protocols are possible. It is contemplated that HTML content could be pushed from the IVR to the first endpoint by embedding an HTML page in the payload section of a Session Initiation Protocol (SIP) message (RFC3261). A SIP INFO method (RFC2976), or another similar method, can be employed. It is also contemplated that other media and audio/video sequencing protocols can be employed. For example, an audio/video protocol that is similar to Macromedia Flash™ can be used while routing voice traffic on the audio end, as well as speech recognition. Still other variations and modifications may occur to those skilled in the art.

All such variations and alternative embodiments are believed to be within the ambit of the claims appended hereto.

What is claimed is:

1. A device for providing simultaneous audio and visual content, comprising:
at least one software component for receiving audio content over a full-duplex audio link and pseudo-rich media content relating to said audio content and which conforms to a markup language specification, and which includes at least one of text, image and hyperlink;
a speaker for reproducing said audio content; and
a display for reproducing said pseudo-rich media content.

2. The device of claim 1, wherein said at least one software component comprises separate browser and phone applications, separate data and phone signaling/audio protocols, separate transport protocol stacks and a packet data stack.

3. The device of claim 1, wherein said at least one software component comprises separate video and phone applications, separate video and phone signaling/audio protocols, separate transport protocol stacks and a packet data stack.

4. The device of claim 1, wherein said at least one software component comprises an integrated video and audio application, an integrated video and audio protocol, a transport protocol stack and a packet data stack.

5. A method of providing simultaneous audio and visual content for a portable electronic device, comprising:
transmitting audio content and pseudo-rich media content relating to said audio content, wherein said pseudo-rich media content conforms to a markup language specification and includes at least one of text, pictures and hyperlinks;
reproducing said audio content from a speaker of said portable electronic device; and
reproducing said pseudo-rich media content on a screen of said portable electronic device.

6. The method of claim 5, further comprising transmitting messages responsive to said audio content and pseudo-rich media content, thereby initiating generation of further audio content and pseudo-rich media content responsive to said messages.

7. A communication system, comprising:
a server for generating simultaneous audio and pseudo-rich media content relating to said audio content, wherein said pseudo-rich media content conforms to a markup language specification and includes at least one of text, pictures and hyperlinks; and
a device for receiving and reproducing said simultaneous audio and pseudo-rich media content, and for transmitting messages to said server responsive to said audio content and pseudo-rich media content, whereupon said server generates further audio content and pseudo-rich media content responsive to said messages.

8. The communication system of claim 7 wherein said server transmits said audio content to said device over a full-duplex audio link and said pseudo-rich media content over a data link.

9. The communication system of claim 7, wherein said device includes separate browser and phone applications, separate data and phone signaling/audio protocols, separate transport protocol stacks, a packet data stack and a physical layer.

10. The communication system of claim 8 wherein said device includes separate video and phone applications, separate video and phone signaling/audio protocols, separate transport protocol stacks, a packet data stack and a physical layer.

11. The communication system of claim 7 wherein said device includes an integrated video and audio application, an integrated video and audio protocol, a transport protocol stack, a packet data stack and a physical layer.

12. The communication system of claim 7 wherein said server implements an Interactive Voice Response (IVR) system.

13. The communication system of claim 12, wherein said Interactive Voice Response (IVR) system includes a voice recognition capability for recognizing and responding to user voiced commands.
